(19) United States
(12) Patent Application Publication
(10) Pub. No.: US 2024/0113509 A1
(43) Pub. Date: Apr. 4, 2024

(54) SURGE PROTECTION BUS BAR

(71) Applicant: viaPhoton, Inc., Aurora, IL (US)

(72) Inventors: Walter Mark HENDRIX, Dallas, TX (US); Elizabeth Grace DABDOUB, Bartlett, IL (US); Keith Samuel MARANTO, Chicago, IL (US); Mark James SMRHA, Chicago, IL (US)

(73) Assignee: viaPhoton, Inc., Aurora, IL (US)

(21) Appl. No.: 18/374,548

(22) Filed: Sep. 28, 2023

Related U.S. Application Data
(60) Provisional application No. 63/412,341, filed on Sep. 30, 2022.

(51) Int. Cl. H02G 5/00

(52) U.S. Cl. CPC H02G 5/00

(57) ABSTRACT

A system implements a surge protection bus bar. The system includes a surge protection device that includes a connection point. The system further includes a carrier assembly juxtaposed to the surge protection device. The carrier assembly includes an interconnection point, an attachment point, and a rigid bar connecting between an interconnection point and the attachment point. A proximal end of the rigid bar integrally forms the interconnection point and a distal end of the rigid bar includes the attachment point.

### CROSS REFERENCE TO RELATED APPLICATIONS

This application claims the benefit of U.S. Provisional Application 63/412,341, filed Sep. 30, 2022, which is incorporated by reference herein.

### BACKGROUND

Cell sites, also referred to as a cell towers or base stations, are components of cellular network infrastructure. Cell sites are physical structures that may be equipped with antennas and communication equipment that enables wireless communication between mobile devices, such as cell phones, and the larger telecommunications network. Cell sites provide wireless coverage and maintain seamless communication by transmitting and receiving signals to and from mobile devices within their coverage area. These sites are strategically placed in locations to ensure optimal coverage and capacity for users. Multiple cell sites are interconnected to form a cellular network that covers a specific geographic area.

Cell sites include several components using electrical power, which may include direct current power. Due to the height and exposure of the cell tower, components at cell sites are susceptible to lightning strikes as well as other electrical anomalies. Surge protection devices may be used to defend against electrical anomalies. A challenge with surge protection devices is to connect components or minimizing the length of conductors between components.

### SUMMARY

In general, in one or more aspects, the disclosure relates to a system that implements a surge protection bus bar. The system includes a surge protection device that includes a connection point. The system further includes a carrier assembly juxtaposed to the surge protection device. The carrier assembly includes an interconnection point, an attachment point, and a rigid bar connecting between an interconnection point and the attachment point. A proximal end of the rigid bar integrally forms the interconnection point and a distal end of the rigid bar includes the attachment point.

In general, in one or more aspects, the disclosure relates to an apparatus forming an interconnection block. The apparatus includes a carrier assembly configured to be juxtaposed to a surge protection device that includes a connection point. The carrier assembly includes an interconnection point, an attachment point, and a rigid bar connecting between an interconnection point and the attachment point. A proximal end of the rigid bar integrally forms the interconnection point and a distal end of the rigid bar that includes the attachment point.

In general, in one or more aspects, the disclosure relates to a method of a surge protection bus bar. The method includes securing a surge protection device within a panel and installing a rigid bar to a carrier to form a carrier assembly. The carrier assembly is configured to be juxtaposed to the surge protection device that includes a connection point. The carrier assembly includes an interconnection point, an attachment point, and a rigid bar connecting between an interconnection point and the attachment point. A proximal end of the rigid bar integrally forms the interconnection point and a distal end of the rigid bar that includes the attachment point. The method further includes attaching the carrier assembly to the surge protection device.

Other aspects of the one or more embodiments will be apparent from the following description and the appended claims.

### BRIEF DESCRIPTION OF DRAWINGS

FIG. 1 shows a system, in accordance with one or more embodiments of the disclosure.

FIG. 2 shows a method in accordance with one or more embodiments of the disclosure.

FIG. 3.1, FIG. 3.2, FIG. 3.3, FIG. 3.4, FIG. 4, FIG. 5.1, FIG. 5.2, FIG. 6, FIG. 7, FIG. 8, FIG. 9.1, FIG. 9.2, FIG. 9.3, FIG. 9.4, FIG. 10, FIG. 11.1, FIG. 11.2, FIG. 12.1, FIG. 12.2, FIG. 13.1, FIG. 13.2, FIG. 14.1, FIG. 14.2, FIG. 15.1, FIG. 15.2, FIG. 15.3, FIG. 15.4 show examples in accordance with one or more embodiments of the disclosure.

Like elements in the various figures are denoted by like reference numerals for consistency.

### DETAILED DESCRIPTION

In general, one or more embodiments a surge protection bus bar is used to minimize lengths of conductors between components and surge protection devices. Minimizing the length of conductors between surge protection devices and other equipment can improve the surge dampening performance of surge protection devices. The bus bar may be incorporated into an interconnection box that is connected to a surge protection device.

Systems of the disclosure provide a compact method to interconnect surge protection devices (SPDs) to both a power source, and to a device that consumes power from the power source. The power source may be a direct current power supply at the base of a cell site. The device that consumes power may be a remote radio unit (RRU), which resides at the top of the cell tower at the cell site.

With a remote radio unit at the top of a cell site tower, lightning strikes are common. The surge protection devices protect the remote radio unit from surge events such as those caused by a lightning strike.

A surge protection device may be colocated with a remote radio unit at the top of the tower and be housed in an environmentally sealed enclosure that mounts to the tower. The size of the enclosure may be based on multiple factors including space and tower design. The space used on the tower by the enclosure has a real estate cost that is determined based on the enclosure size. The tower structure is designed to support the mounted equipment at high wind loads (e.g., 150 mile per hour winds). The surface area of the faces of the enclosure directly impacts the tower wind load, and therefore the structural design and cost of the cell site tower.

The tower top surge protection device enclosure (also referred to as a panel) supports the surge suppression requirements of the cell site and has a minimal size. At the base of the tower, in an outdoor cabinet or hut, a non-environmentally sealed rack mount enclosure (which also may be referred to as a panel) may house additional surge protection devices to suppress surges that can travel down the tower trunk power cable and into the outdoor cabinet or hut at the base of the tower. Rack space is at a premium and the surge protection device solution, including the interconnects, may include a minimal size.

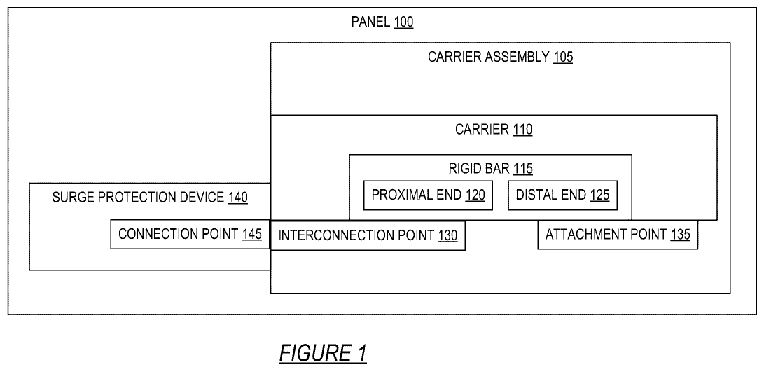

Turning to FIG. 1, the panel (100) may be installed at a cell site. In one embodiment, the panel (100) is a panel installed at a top of a tower of the cell site. In one embodiment, the panel (100) is a panel in a server rack at a base of the cell site. In one embodiment, the panel (100) is installed in a server rack that is not at a cell site. The panel (100) includes the carrier assembly (105) and the surge protection device (140).

The carrier assembly (105) is an assembly that includes the carrier (110) and the rigid bar (115) with the internet connection point (130) and the attachment point (135). The carrier assembly (105) provides the attachment point (135) extended from the connection point (145) of the surge protection device (140) at a minimal distance to improve the performance of surge protection device (140) for a component connected to the attachment point (135). In one embodiment, the carrier assembly (105) is juxtaposed to the surge protection device (140).

The carrier (110) is a housing that carries the rigid bar (115). In one embodiment, the carrier (110) is made of rigid plastic with features to secure the rigid bar (115) and expose the attachment point (135) and the interconnection point (130).

The rigid bar (115) is a bus bar that provides electrical conductivity between the connection point (145) and the attachment point (135). In one embodiment, the rigid bar (115) may be made of an electrically conductive substance, including copper, silver, gold, iron, etc. In one embodiment, the rigid bar (115) may have a regular cross section configured to slide into a receptacle at the connection point (145). The rigid bar (115) includes the proximal end (120) and the distal end (125).

The proximal end (120) is an end of the rigid bar (115). The proximal end (120) is at the interconnection point (130).

The distal end (125) is an end of the rigid bar (115). The distal end (125) is at the attachment point (135).

The interconnection point (130) is a point of the carrier assembly (105) that connects to the connection point (145) of the surge protection device (140). In one embodiment, the interconnection point (130) includes a portion of the rigid bar (115) at the proximal end (120) of the rigid bar (115) that slides into the connection point (145) of the surge protection device (140).

The attachment point (135) is a point of the carrier assembly (105) to which terminal connectors (not shown) are attached. The terminal connectors are attached to wires that run to the components that are connected to the surge protection device (140) and for which the surge protection device (140) provides surge protection.

The surge protection device (140) is a device that safeguards electrical and electronic equipment from voltage surges, transients, electrical spikes, and other electrical anomalies. The electrical anomalies may occur due to various factors, including lightning strikes, power grid switching, the operation of high-powered electrical equipment, etc.

In one embodiment, the surge protection device (140) includes surge protection components that divert excessive voltage and current away from the equipment under protection when a surge or transient event occurs. Surge protection components may include metal oxide varistors (MOVs), gas discharge tubes (GDTs), silicon avalanche diodes, etc.

The operation of the surge protection device (140) may involve the detection of voltage spikes or surges that surpass a predetermined threshold, known as a clamping voltage. When such events occur, the surge protection device (140) may rapidly (e.g., within 100 milliseconds) redirect the surplus energy to ground or another secure pathway. Redirecting the surplus energy prevents the surge from reaching and potentially damaging the electronic equipment connected to the surge protection device (140), which can include communications equipment, computers, antennas, radios, etc.

The connection point (145) is the point to which the equipment being safeguarded from surges and voltage spikes is connected. In one embodiment, the connection point (145) may be an input terminal or an output terminal of the surge protection device (140). The connection point (145) is the point through which electrical current flows from the surge protector to the connected equipment, providing protection to the connected devices and components.

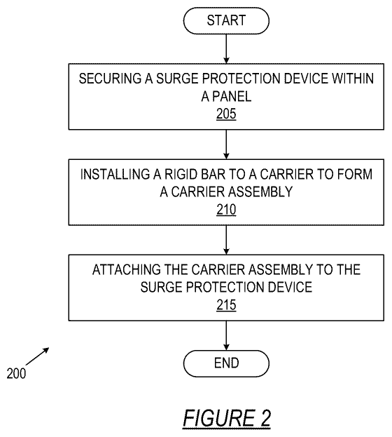

Turning to FIG. 2, a method of installing a rigid bar as part of a carrier assembly is described. The method minimizes distance between an attachment point of the carrier assembly and the connection point of the surge protection device.

Step 205 includes securing a surge protection device within a panel. In one embodiment, the surge protection device may be secured by fastening the surge protection device to a rail within the panel.

Step 210 includes installing a rigid bar to a carrier to form a carrier assembly. In one embodiment, the carrier assembly is configured to be juxtaposed to the surge protection device comprising a connection point. In one embodiment, the carrier assembly includes an interconnection point, an attachment point, and a rigid bar. In one embodiment, the rigid bar connects between an interconnection point and the attachment point. In one embodiment, a proximal end of the rigid bar integrally forms the interconnection point and a distal end of the rigid bar includes the attachment point.

Step 215 includes attaching the carrier assembly to the surge protection device. In one embodiment, the carrier assembly is attached to the surge protection device by sliding and interconnection point of the carrier assembly into the connection point of the surge protection device.

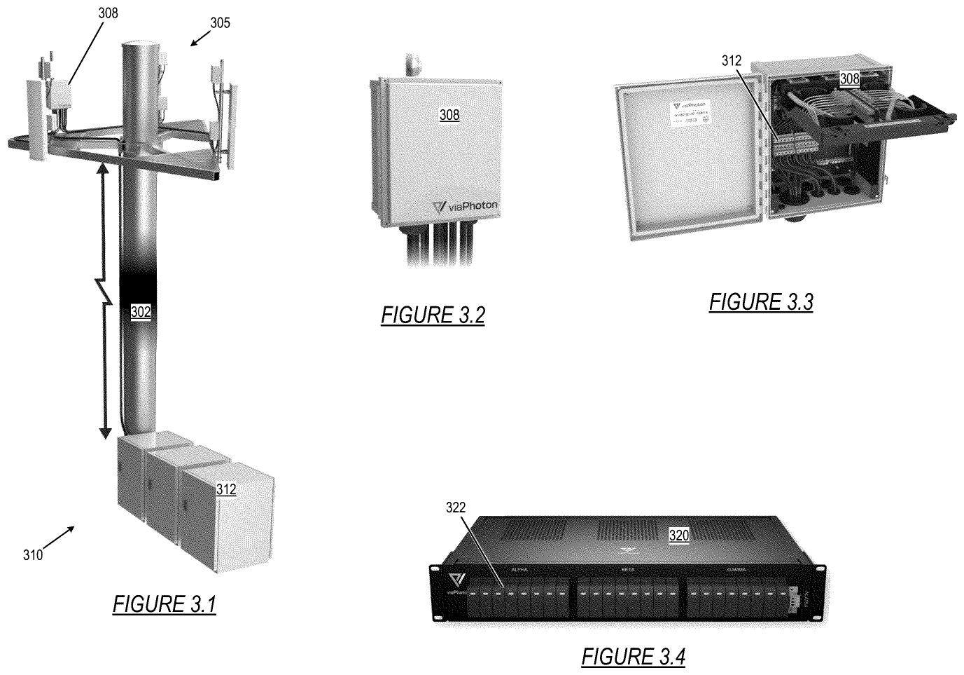

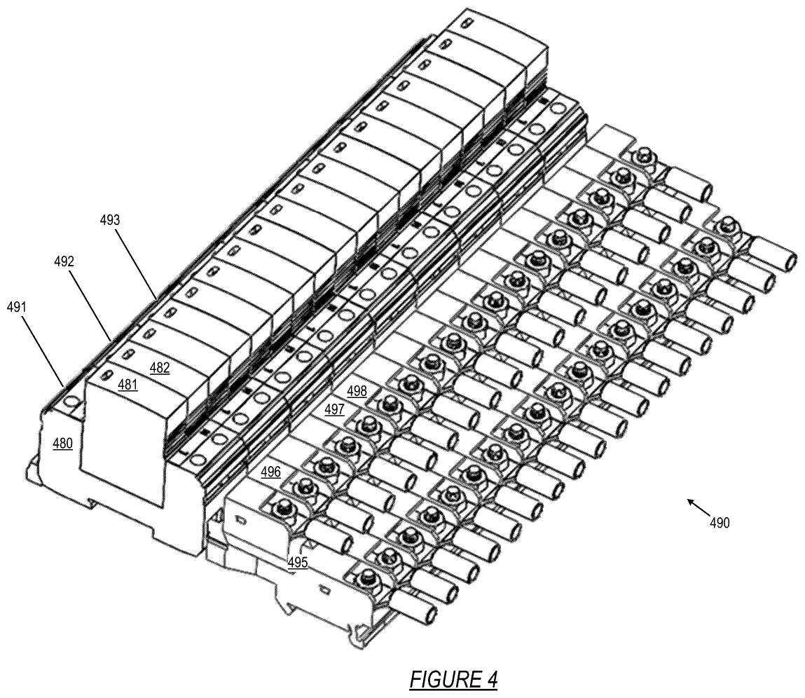

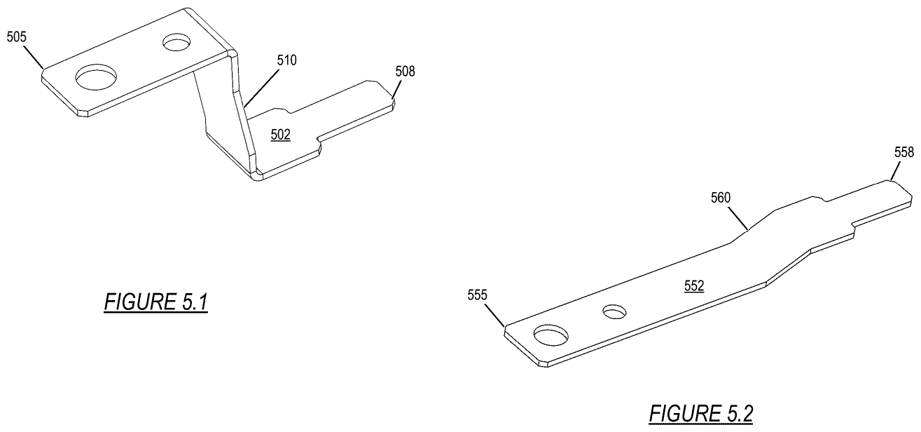

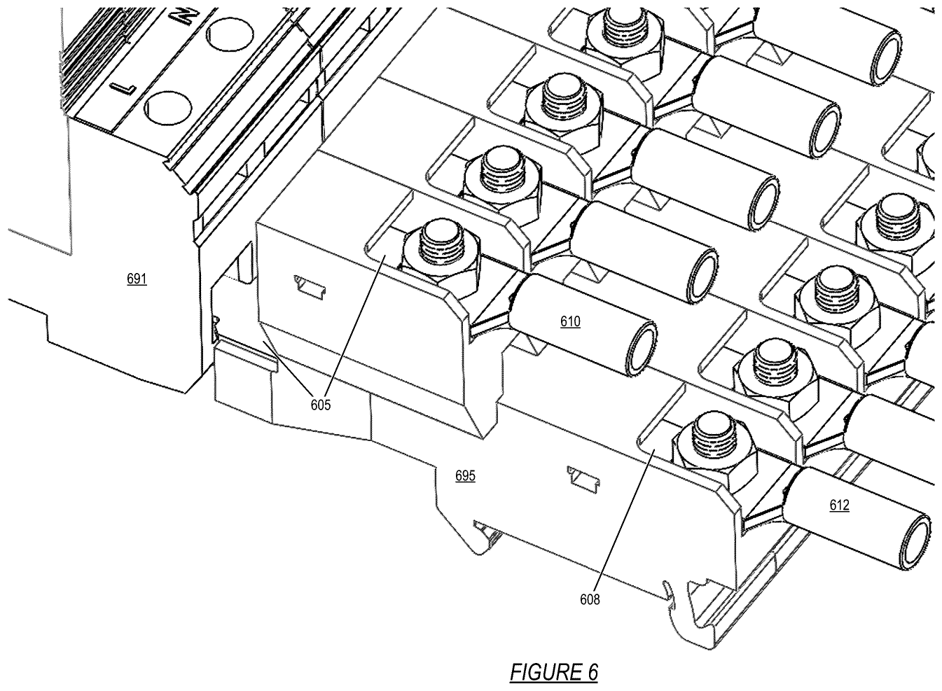

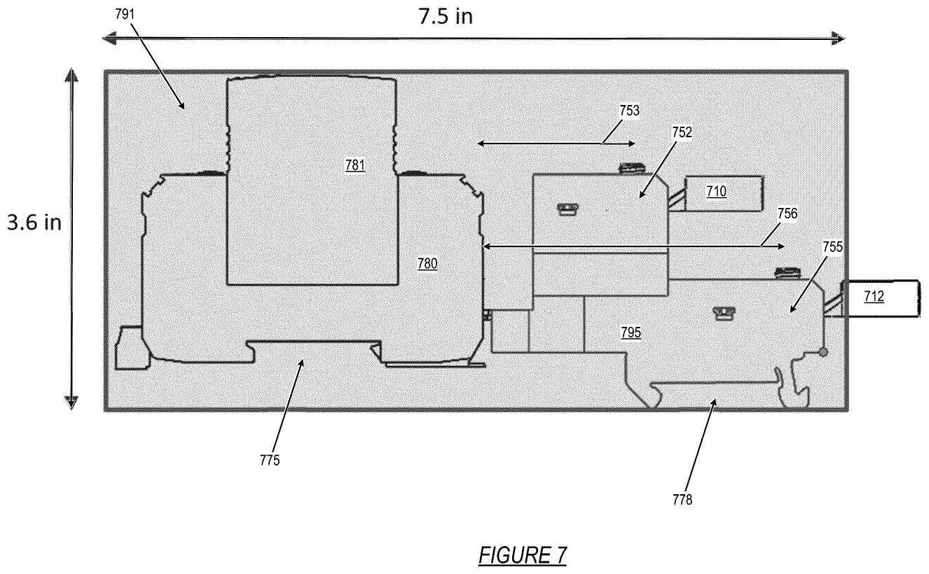

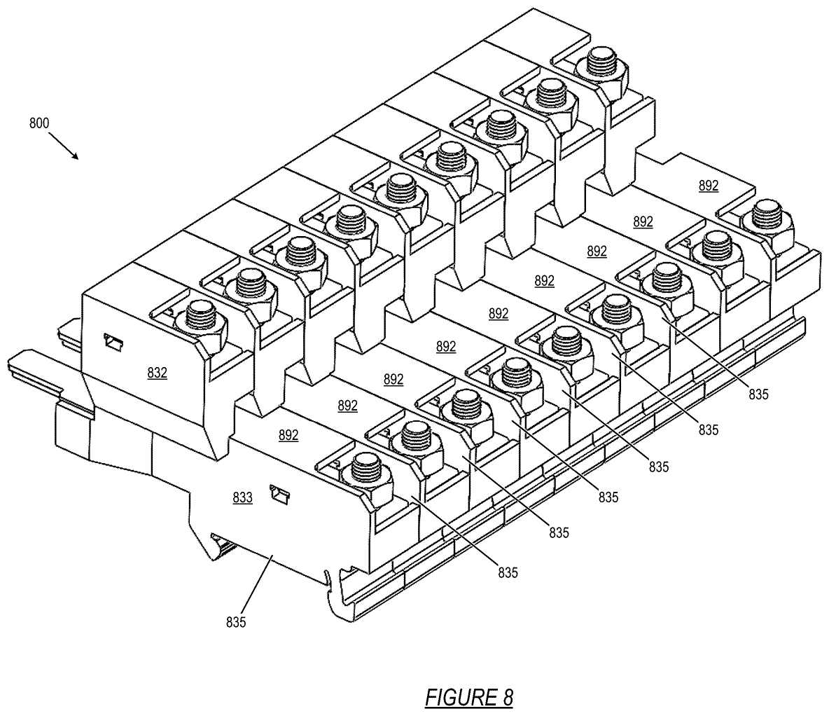

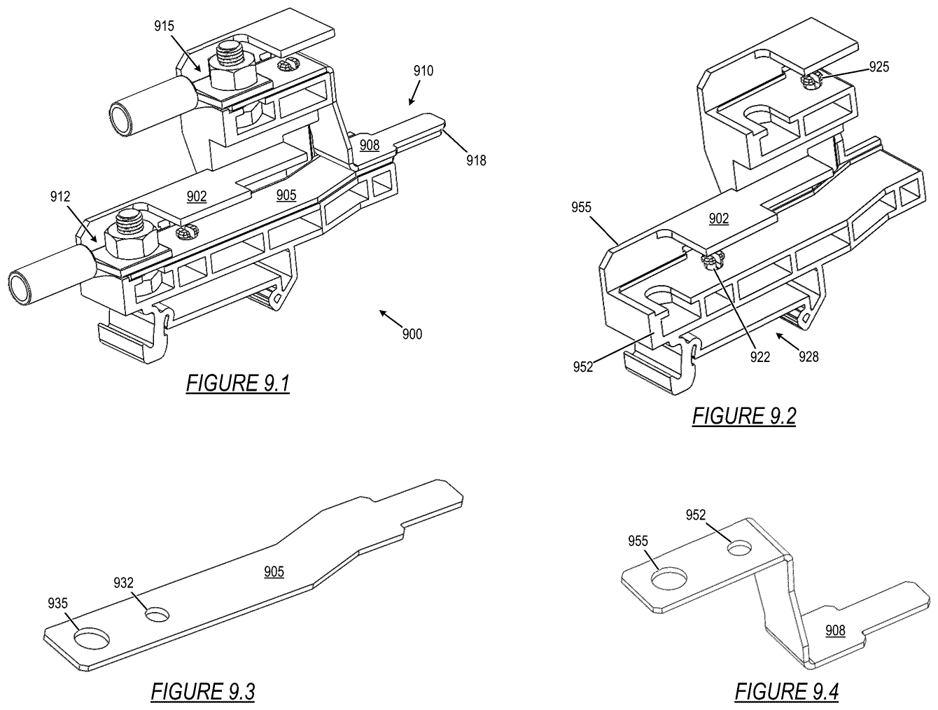

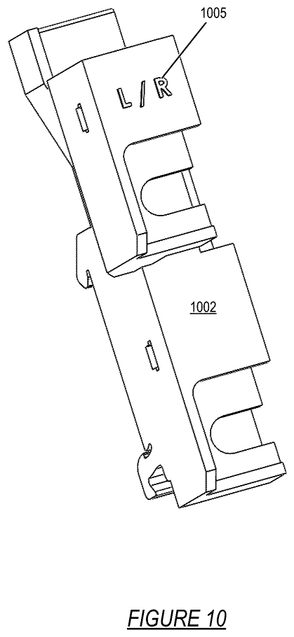

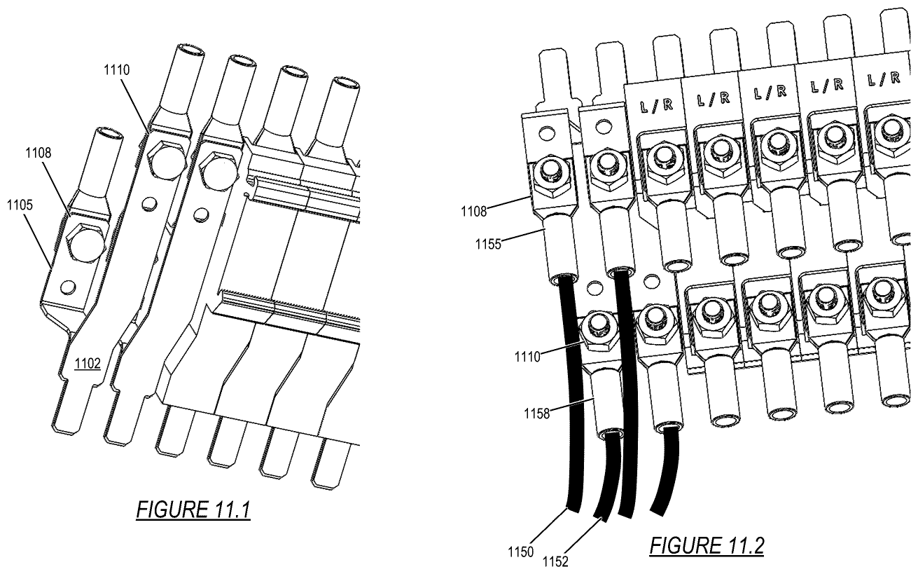

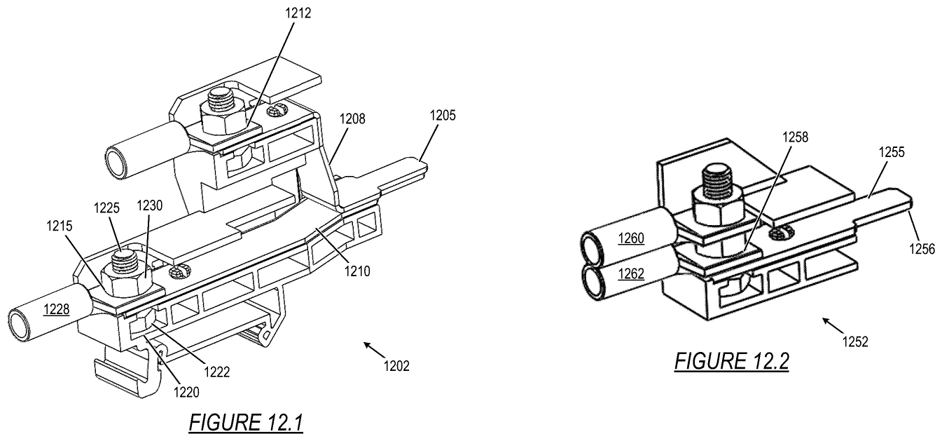

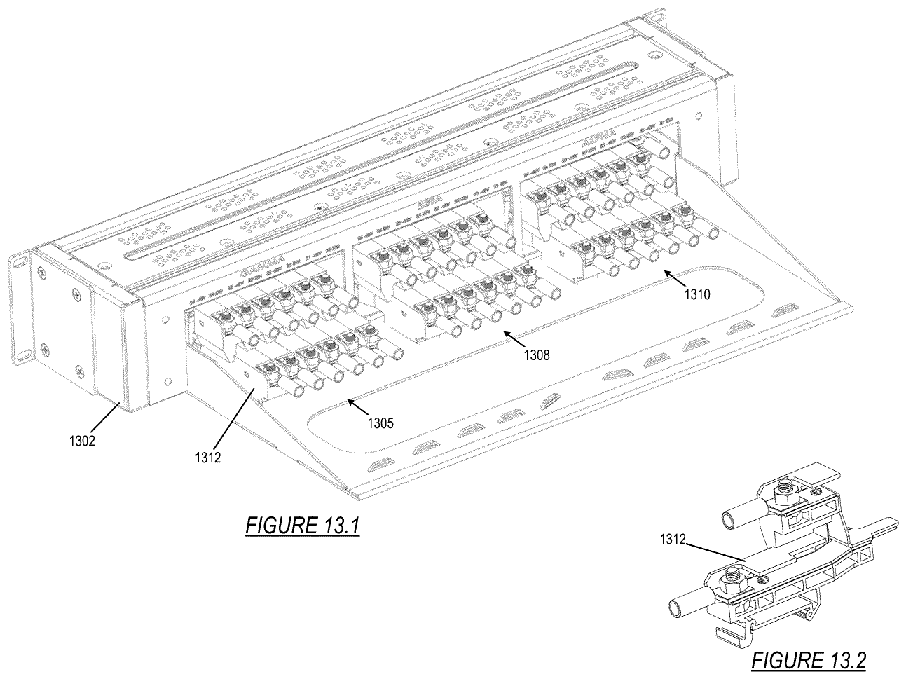

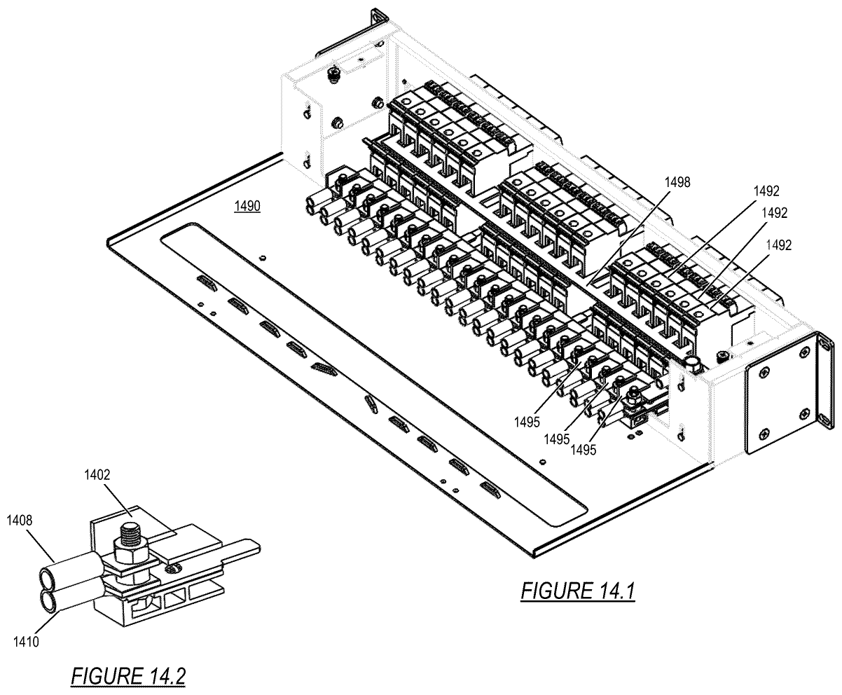

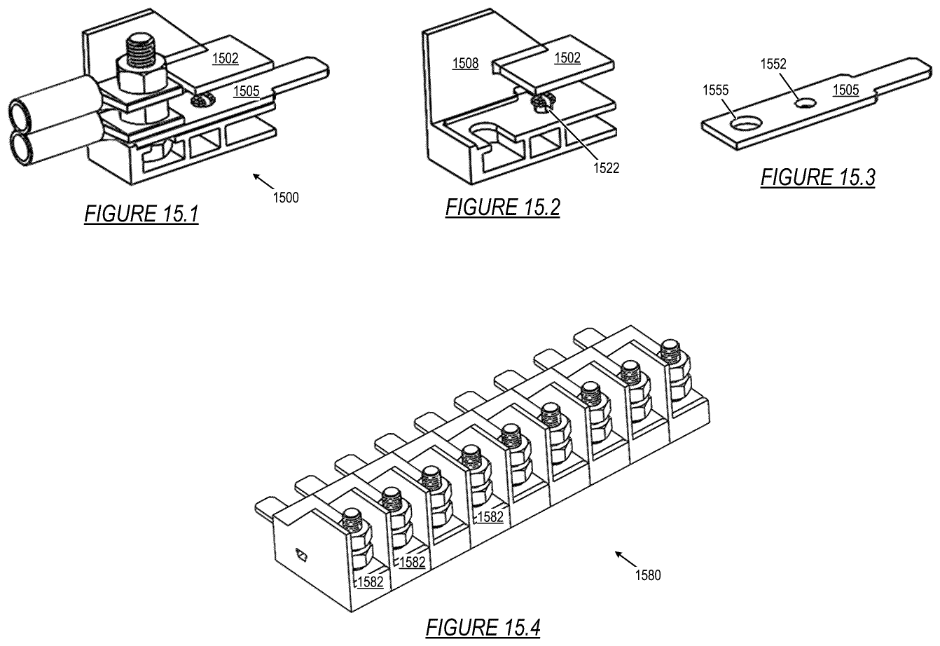

Turning to FIG. 3.1, a cell site includes the tower (302). At the top (305) of the tower (302), several communication equipment components are located, which may include computers, radios, antennas, etc., as well as the panel (308), which is further described in FIG. 3.2 and FIG. 3.3.

At the base (310) of the tower (302), several racks are located, including the rack (312). The racks at the base (310) include several panels and the rack (312) includes the panel (320) of FIG. 3.4.

Turning to FIG. 3.2, the panel (308) provides search protection to the equipment at the top (305) of the tower (302). The panel (308) is environmentally sealed to protect the components within the panel (308).

Turning to FIG. 3.3, the panel (308) is in an open position and includes several cables routed within. The cables may include fiber optic cables and electrical cables. Electrical cables may include power cables for equipment within the panel (308) and the other equipment at the top (305) of the tower (302). The components within the panel (308) include the surge protection devices (312) to protect the electrical lines from lightning strikes and other power anomalies.

Turning to FIG. 3.4, the panel (320) is one of several panels from the rack (312) of FIG. 3.1. The panel (320) includes several surge protection devices (322) connected to an interconnection block within the panel (320). The surge protection devices (322) of the panel (320) protect the electrical components at the base (310) of the tower (302) of FIG. 3.1.

Turning to FIG. 4, the protection assembly (490) is shown. The protection assembly (490) includes multiple surge protection devices (491) through (493) and carrier assemblies (495) through (498). Each of the surge protection devices may be connected to one or more carrier assemblies.

The surge protection device (491) includes the base element (480), and two surge protection plugs (481) and (482). The surge protection plug (481) protects equipment connected to the carrier assembly (495). The surge protection plug (482) protects equipment connected to the carrier assembly (496), which may be the same equipment that is connected to the carrier assembly (495).

In one embodiment, the protection assembly (490) includes nine surge protection devices (including the surge protection devices (491) through (493)). Each of the surge protection devices are in a “1+1” configuration with attachment points for lines “L” and returns “N” (which may also be referred to as load “L” lines and neutral “N” lines). The attachment points may be connected to remote radio units (not shown), which are protected by the surge protection devices of the protection assembly (490). The protection assembly (490) may be in a panel, such as the panel (308) of FIG. 3.3. In one embodiment, the surge protection device (491) may be at position “1” of the nine positions for the nine surge protection devices of the protection assembly (490).

In one embodiment, the carrier assemblies within the protection assembly (490) may be color coded. For example, the carrier assembly (495) may be color coded as black to signify a load line “L” and the carrier assembly (496) may be color coded as red to signify a return line “N”.

Turning to FIG. 5.1, the upper compact bus bar (502) is illustrated. The upper compact bus bar (502) is a rigid bar of a carrier assembly (e.g., the carrier assembly (495) of FIG. 4). The upper compact bus bar (502) includes two folds to lift the distal end (505) of the upper compact bus bar (502) above the proximal end (508). The upper compact bus bar (502) includes the lateral bend (510) to laterally offset the distal end (505) literally from the proximal end (508).

Turning to FIG. 5.2, the lower compact bus bar (552) is illustrated. The lower compact bus bar (552) is a rigid bar of a carrier assembly (e.g., the carrier assembly (495) of FIG. 4). The lower compact bus bar (552) the proximal end (558) and the distal end (555) are in the same vertical plane. The lower compact bus bar (552) includes the lateral bend (560) to laterally offset the distal end (555) from the proximal end (558). The lateral bend (560) is in the opposite direction from the lateral bend (510) of FIG. 5.1 to stagger the distal end (555) of the lower compact bus bar (552) from the distal end (505) of the upper compact bus bar (502) of FIG. 5.1.

Turning to FIG. 6, the surge protection device (691) is connected to the carrier assembly (695). The carrier assembly (695) includes the upper bar (605), which is a rigid upper compact bus bar. The carrier assembly (695) also includes the lower bar (608), which is a rigid lower compact bus bar.

The proximal ends of the upper bar (605) and the lower bar (608) connect to the surge protection device (691). The distal ends of the upper bar (605) and the lower bar (608) include attachment points for the terminal connectors (610) and (612). The upper bar (605) and the lower bar (608) minimize a length between the surge protection device (691) and the terminal connectors (610) and (612) while providing accessibility to rewire or reconnect components to the surge protection device (691) without disturbing the connection between the carrier assembly (695) and the surge protection device (691). The terminal connectors (610) and (612) form a “y connection” to the surge protection device (691) to limit voltage differentials.

Turning to FIG. 7, the surge protection device (791) is connected to the carrier assembly (795). The surge protection device (791) includes the surge protection plug (781) and the base element (780). Incorporated as part of the base element (780), the surge protection device (791) includes the rail adapter (775). The rail adapter (775) may be used to secure the surge protection device (791) to a panel (not shown). The carrier assembly (795) also includes the rail adapter (778), which may be used to secure the carrier assembly to a separate rail in a panel (not shown). The surge protection device (791) with the carrier assembly (795) forms a compact package to minimize the distance between the terminal connectors (710) and (712) and the connection point of the surge protection device (791) and minimize the cross sectional footprint of the surge protection device (791) with the carrier assembly (795). For example, with at length of 7.5 inches and a height of 3.6 inches, the cross sectional footprint is 27 square inches.

In one embodiment, the attachment point (752) of the carrier assembly (795) is within the length (753) to the surge protection device (791). The length (753) is about half the length of the surge protection device (791), which is about 3 inches (or about 75 millimeters) long. In one embodiment, the attachment point (755) of the carrier assembly (795) is within the length (756), which is about the length of the surge protection device (791) of about 3 inches (or about 75 millimeters) long.

Turning to FIG. 8, the interconnection block (800) (also referred to as a bus assembly) includes multiple carrier assemblies (892). Each of the carrier assemblies (892) includes two attachment points. Each of the carrier assemblies (892) includes an upper portion (832) with one attachment point and a lower portion (833) with a second attachment point, which may be made by injection molding of an insulating material (e.g., plastic). The carrier assemblies (892) are juxtaposed together to form the interconnection block (800). Each of the carrier assemblies (892) includes a closed side (835) that is opposite from an open side through which the rigid bars are inserted into the carrier assemblies (892)

Turning to FIG. 9.1, the carrier assembly (900) is displayed. The carrier assembly (900) implements a surge protection bus bar. The carrier assembly (900) includes the carrier (902), the first bus bar (905), and the second bus bar (908). The first bus bar (905) and the second bus bar (908) are electrically connected to form the combined busbar (910) with multiple attachment points. The multiple attachment points include the first connection point (912) and the second connection (915). Electrical cables are connected to the attachment points (912) and (915) so that a surge protection device (not shown) connected to the proximal end (918) of the combined bus bar (910). The bus bars (905) and (908) of the system may be made of electrically conductive material and the carrier (902) made of an electrically insulative material.

Turning to FIG. 9.2, the carrier (902) is displayed with the open side (952) for receiving the bus bars (905) and (908) of FIG. 9.1. The carrier (902) includes the integrated first fastening member (922) to secure the bus bar (905) of FIG. 9.1 to the carrier (902). The carrier (902) further includes the second integrated fastening member (925) to secure the bus bar (908) of FIG. 9.1 to the carrier (902). In one embodiment, the fastening members (922) and (925) are integrally formed as part of the carrier (902). The carrier (902) includes the open side (952) to receive components to form the carrier assembly (900) (of FIG. 9.1). The carrier (902) includes the mounting features and structure (928), which may be used to secure the carrier (902) (or the carrier assembly (900) of FIG. 9.1) to a box, panel, Deutsches Institut für Normung (DIN) rail, etc.

Turning to FIG. 9.3, the bus bar (905) includes the carrier opening (932) and the terminal opening (935). The carrier opening (932) is a fastening member of the bus bar (908) used to secure the bus bar (905) to the carrier (902) (of FIG. 9.2) using the fastening member (922). The terminal opening (935) is a fastening member of the bus bar (908) used to secure a cable or lug to the bus bar (905) at the attachment point (912), as shown in FIG. 9.1.

Turning to FIG. 9.4, the bus bar (908) includes the carrier opening (952) and the terminal opening (955). The carrier opening (952) is a fastening member of the bus bar (908) used to secure the bus bar (908) to the carrier (902) (of FIG. 9.2) using the fastening member (925). The terminal opening (955) is a fastening member of the bus bar (908) used to secure a cable or lug to the bus bar (908) at the attachment point (915), as shown in FIG. 9.1.

Turning to FIG. 10, the carrier (1002) is shown in a perspective view. The carrier (1002) includes the text (1005) “L/R” to indicate that the carrier (1002) may be used for either a load line or a return line. The text may be removed or obfuscated after installation to identify the line with which the carrier (1002) is used. In one embodiment, the text may be injection molded as part of the carrier (1002). In one embodiment, the text (1005) may specify one type of line (e.g., “L” or “R”).

Turning to FIG. 11.1, rigid bars are depicted with and without carriers from an under side perspective. The lower bar (1102) and the upper bar (1105) include opposing bends formed in the opposite direction along with offset elevations to improve access to the attachment points (1108) and (1110) of the upper and lower bars (1105) and (1102).

Turning to FIG. 11.2, rigid bars and carrier assemblies are depicted from an upper side perspective. The cables (1150) and (1152) are connected to the attachment points (1108) and (1110) through the terminal connectors (1155) and (1158). Lateral and vertical staggering of the attachment points of the rigid bars and carrier assemblies provides clearance for lug tightening and for cable routing in a compact design.

Turning to FIG. 12.1, the carrier assembly (1202) is shown from an open side perspective. The carrier assembly (1202) includes the interconnection point (1205) configured to slide into a search protection device (not shown). The interconnection point (1205) is a “Y” connection point connecting the upper bar (1208) and the lower bar (1210). The attachment points (1212) and (1215) are separated to provide independent access. The opening (1220) is shaped to receive and secure the head (1222) of the bolt (1225) to which the terminal connector (1228) is attached. The terminal connector (1228) is secured by the nut (1230). In one embodiment, the opening (1220) is sized to allow the head (1222) of the bolt (1225) to be inserted but to prevent the bolt (1225) from being rotated. In one embodiment, the attachment point (1212) and the attachment point (1215) are within a proximity ranging between about half a length and a full length of a surge protection device (not shown) to which the carrier assembly (1202) may be attached.

In one embodiment, the attachment point (1212) is within a radial proximity of about 1.9 inches (or 48 millimeters) to the interconnection point (1205). The proximity forms a close proximity between the attachment point (1212) and the connection point of a surge protection device (not shown) to which the carrier assembly (1202) may be attached. The radial proximity corresponds to a horizontal proximity of about 1.5 inches (or 38 millimeters) to the interconnection point (1205).

In one embodiment, the attachment point (1215) is within a proximity of about half a length of a surge protection device to which the carrier assembly (1202) may be connected. In one embodiment, the attachment point (1215) is within a proximity of about 3 inches (or 75 millimeters) to the interconnection point (1205) to form a close proximity between the attachment point (1215) and the connection point of a surge protection device (not shown) to which the carrier assembly (1202) may be attached.

Turning to FIG. 12.2, the carrier assembly (1252) is shown from an open side perspective. The carrier assembly (1252) includes a single bus bar, the bus bar (1255). The bus bar (1255) includes the attachment point (1258) to which multiple terminal connectors, including the terminal connectors (1260) and (1262), are stacked and attached.

In one embodiment, the attachment point (1258) is within a proximity ranging between about half a length and a full length of a surge protection device (not shown) to which the carrier assembly (1252) may be attached. In one embodiment, the attachment point (1258) is within a proximity of about 1.5 inches (or 38 millimeters) to the interconnection point (1256). The proximity forms a close proximity between the attachment point (1258) and a surge protection device (not shown) to which the carrier assembly (1252) may be attached.

Turning to FIG. 13.1, the panel (1302) includes the interconnection blocks (1305), (1308), and (1310) that each have multiple carrier assemblies. The interconnection blocks (1305), (1308), and (1310) are labeled “GAMMA”, “BETA”, and “ALPHA” on the panel (1302).

Turning to FIG. 13.2, the carrier assembly (1312) is depicted. The carrier assembly (1312) includes separate attachment points and forms part of the interconnection block (1305) labeled “GAMMA” on the panel (1302) of FIG. 13.1.

Turning to FIG. 14.1, the panel (1490) is illustrated. The panel (1490) includes multiple surge protection devices (1492) and carrier assemblies (1495). Three groups of six surge protection devices (1492) for a total of eighteen are shown. The eighteen surge protection devices (1492) are connected to eighteen of the twenty-two carrier assemblies (1495). The surge protection devices (1492) share a common bus (1498). Different quantities of the surge protection devices (1492) and the carrier assemblies (1495) may be used.

Turning to FIG. 14.2, the carrier assembly (1402) is one of the carrier assemblies (1495) of FIG. 14.1. The carrier assembly (1402) includes a single attachment point for multiple terminal connectors, e.g., the terminal connectors (1408) and (1410).

Turning to FIG. 15.1, the carrier assembly (1500) is portrayed from an open side. The carrier assembly (1500) includes the carrier (1502) with a single bus bar, the bus bar (1505). The bus bar (1505) has a single attachment point for multiple cables or lugs.

Turning to FIG. 15.2, the carrier (1502) includes the fastening member (1522). The fastening member (1522) is used to secure the bus bar (1505) (of FIG. 1) to the carrier (1502). The carrier (1502) includes the divider (1508) that closes a side of the carrier (1502) and divides the carrier (1502) from other carriers and carrier assemblies when juxtaposed with other carriers and carrier assemblies.

Turning to FIG. 15.3, the bus bar (1505) is displayed. The bus bar (1505) includes the carrier opening (1552) and the terminal opening (1555). The carrier opening (1552) is a fastening member of the bus bar (1505) used to secure the bus bar (1505) to the carrier (1502) (of FIG. 15.2) using the fastening member (1522) (of FIG. 15.2). The terminal opening (1555) is a fastening member of the bus bar (1505) used to secure one or more cables to the bus bar (1505), as shown in FIG. 15.1.

Turning to FIG. 15.4, the bus assembly (1580) includes multiple carrier assemblies (1582), which are shown in perspective form a closed side. Each of the carrier assemblies (1582) includes a single connection point for multiple cables, lugs, terminal connectors, etc.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions, features, and elements of the figures may be combined and may include or be included within the features described in the other figures of the application. Similarly named features and elements between different figures may refer to the same feature or element. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

The term “about” is in accordance with what one of ordinary skill in the art would understand in light of the disclosure. In one embodiment, the term “about” may mean within plus or minus ten percent.

Further, unless expressly stated otherwise, the word “or” is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A system comprising:
a surge protection device comprising a connection point;
a carrier assembly juxtaposed to the surge protection device and comprising
an interconnection point,
an attachment point,
a rigid bar connecting between an interconnection point and the attachment point,
wherein a proximal end of the rigid bar integrally forms the interconnection point and a distal end of the rigid bar comprises the attachment point.

2. The system of claim 1, wherein the attachment point connects to a stacked plurality of terminals and wherein the attachment point is within a proximity ranging between half a length and a length of the surge protection device.

3. The system of claim 1, wherein the attachment point is a first attachment point and wherein the system further comprises:
the first attachment point connecting to a first terminal; and
a second attachment point, of the carrier assembly, connecting to a second terminal.

4. The system of claim 1, further comprising:
a carrier of the carrier assembly securing the rigid bar.

5. The system of claim 1, further comprising:
a carrier of the carrier assembly comprising a bar placement member.
the rigid bar comprising a fastening member structured to receive the bar placement member;

6. The system of claim 1, further comprising:
the attachment point comprising a bolt secured to a carrier of the carrier assembly; and
the attachment point comprising a nut fastened to the bold to secure a terminal to the attachment point.

7. The system of claim 1, further comprising:
the surge protection device comprising a surge protection plug, a base element, and a rail adapter,
wherein the base element comprises the connection point of the surge protection device.

8. The system of claim 1, further comprising:
a carrier of the carrier assembly, wherein the housing comprises an open side and a closed side, wherein the open side is configured to receive the rigid bar.

9. The system of claim 1, further comprising:
a panel affixed to a tower, wherein the panel comprises the carrier assembly and the surge protection device.

10. The system of claim 1, further comprising:
a panel affixed to a base of a tower, wherein the panel comprises the carrier assembly and the surge protection device.

11. An apparatus forming an interconnection block, the apparatus comprising:
a carrier assembly configured to be juxtaposed to a surge protection device comprising a connection point, wherein the carrier assembly comprises:
an interconnection point,
an attachment point,
a rigid bar connecting between an interconnection point and the attachment point,
wherein a proximal end of the rigid bar integrally forms the interconnection point and a distal end of the rigid bar comprises the attachment point.

12. The apparatus of claim 11, wherein the attachment point connects to a stacked plurality of terminals and wherein the attachment point is within a proximity ranging between half a length and a length of the surge protection device.

13. The apparatus of claim 11, wherein the attachment point is a first attachment point and wherein the system further comprises:
the first attachment point connecting to a first terminal; and
a second attachment point, of the carrier assembly, connecting to a second terminal.

14. The apparatus of claim 11, further comprising:
a carrier of the carrier assembly securing the rigid bar.

15. The apparatus of claim 11, further comprising:
a carrier of the carrier assembly comprising a bar placement member.
the rigid bar comprising a fastening member structured to receive the bar placement member;

16. The apparatus of claim 11, further comprising:
the attachment point comprising a bolt secured to a carrier of the carrier assembly; and
the attachment point comprising a nut fastened to the bold to secure a terminal to the attachment point.

17. The apparatus of claim 11,
wherein the surge protection device comprises a surge protection plug, a base element, and a rail adapter,
wherein the base element comprises the connection point of the surge protection device.

18. The apparatus of claim 11, further comprising:
a carrier of the carrier assembly, wherein the housing comprises an open side and a closed side, wherein the open side is configured to receive the rigid bar.

19. The apparatus of claim 11, further comprising:
a panel affixed to a tower, wherein the panel comprises the carrier assembly and the surge protection device.

20. A method comprising:
securing a surge protection device within a panel;
installing a rigid bar to a carrier to form a carrier assembly, wherein the carrier assembly is configured to be juxtaposed to the surge protection device comprising a connection point, wherein the carrier assembly comprises:
an interconnection point,
an attachment point,
a rigid bar connecting between an interconnection point and the attachment point, and
wherein a proximal end of the rigid bar integrally forms the interconnection point and a distal end of the rigid bar comprises the attachment point; and
attaching the carrier assembly to the surge protection device.
